(19) United States
(12) Patent Application Publication
(10) Pub. No.: US 2015/0242771 A1
(43) Pub. Date: Aug. 27, 2015

(54) GENERATING AN OUTPUT BASED ON COLLECTING INFORMATION RELATING TO A CASE

(71) Applicant: HEWLETT-PACKARD DEVELOPMENT COMPANY, L.P., Houston, TX (US)

(72) Inventors: Hamid Reza Motahari Nezhad, Palo Alto, CA (US); Susan Deborah Spence, Palo Alto, CA (US); Sven Graupner, Palo Alto, CA (US); Claudio Bartolini, Palo Alto, CA (US)

(21) Appl. No.: 14/439,887

(22) PCT Filed: Oct. 31, 2012
(86) PCT No.: PCT/US2012/062679

§ 371 Date: Apr. 30, 2015

(51) Int. Cl. G06Q 10/06; G06F 17/30; G06Q 50/00; G06F 17/24

(52) U.S. Cl. CPC G06Q 10/0631; G06F 17/241; G06F 17/30958; G06Q 50/01

(57) ABSTRACT

Information relating to usage of entities of a case is collected, where the entities include tasks and an artifact, and the entities are to interact over a social network. An analysis output is generated based on the collected information.

### BACKGROUND

Personnel of an enterprise (e.g. business concern, government organization, educational organization, etc.) can perform various different activities, such as information technology activities, sales activities, legal activities, product or service development activities, and so forth. The activities can be managed as cases. Case management can involve a mix of automated work and human work.

The activities of a case can include tasks and processes, where each process includes a corresponding collection of inter-related tasks. Personnel at an enterprise may manage a relatively large amount of cases. As the volume of cases and the complexity of cases increase, traditional techniques and systems for case management are often inefficient.

### BRIEF DESCRIPTION OF THE DRAWINGS

Some embodiments are described with respect to the following figures:

FIG. 1 is a flow diagram of a case management process including feedback analysis in a case management social networking framework, according to some implementations;

FIG. 2 is a graph depicting a process according to some examples;

FIG. 3 is a block diagram of an example arrangement of a case management social networking system in accordance with some implementations;

FIG. 4 is a flow diagram of a case management process including feedback analysis in a case management social networking framework, according to further implementations; and

FIG. 5 is a block diagram of a system that is capable of performing social networking case management according to some implementations.

### DETAILED DESCRIPTION

A case can include information relating to various entities that allow work to be performed to achieve a respective goal. In some implementations, a case can include artifacts, tasks, processes that contain inter-related tasks, and other entities. In other implementations (discussed further below), a case can include other types of entities. More generally, a case can be a container of information related to handling an engagement (e.g. an engagement relating to sales of a product or service, an engagement relating to patient care, etc.). Managing a case can involve both human work and automated work.

To provide more efficient and flexible case management techniques and systems, a social networking framework can be employed for case management. Such a framework can be referred to as a case management social networking framework. In the social networking framework, various entities associated with a case can be provided as active entities that are able to interact with each other and with one or multiple actors (humans or automated systems) through a social network. A “social network” can refer to an information sharing system that allows for participants (including the active entities, humans, and/or automated systems) to exchange information with each other. A social network can be implemented within an enterprise, such as a business concern, educational organization, government organization, and so forth. Alternatively, a social network can be provided across multiple enterprises, or alternatively, a social network can be a public social network that is more widely available to users. In accordance with some implementations, a social network can be configured to become a productivity tool that can aid in getting work done by users.

As noted above, the different types of entities that can be associated with a case can include a process, a task, and an artifact. The case itself can also be considered an entity in a case management social networking framework. In some implementations, cases, processes, tasks, and artifacts are considered first class entities in the social network. First class entities are entities that are peers of each other—in other words, the entities can interact with each other. As noted above, the entities (including a case, a process, a task, and an artifact) are active entities, where an active entity is an entity that can receive and emit events, and that can be connected to actors of the social network to allow for interaction between the active entities and the actors. Events received and emitted by an active entity can include various information, including information regarding status updates, information regarding state changes of an active entity, and other information.

The active entities used in the case management social networking framework according to some implementations can provide at least some of the following. A status update provided by a first active entity can trigger a notification of the status update to one or multiple other active entities. In addition, an automated technique is provided to identify one or multiple active entities that may be affected as a result of a state change in a case—for example, information relating to the state change of the case can be propagated to interested active entities. A state change of a case can also trigger predefined action(s), which can be defined in a case template or by an ad-hoc rule specified by an actor. An example type of an ad-hoc rule can be an event-condition-action rule where an event triggers the action if the condition is met. A case may have one or multiple event-condition-action rules, which can be defined in an ad hoc manner by case actors to allow for personalized management of cases beyond predetermined generic rules. A case can have one or multiple followers, who can receive updates from the case.

In some implementations, reference is made to a case that includes processes, tasks, and artifacts. In other implementations, a case can include other entities. For example, a case can include information elements, a roadmap, and a process. Information elements can include attributes of the case and artifacts (documents). A roadmap (which is also an active entity) includes checkpoints (which can be considered milestones or synchronization points) and decision points (points at which decisions can be made). A case manager can define the set of information elements that are to be used at the checkpoint or decision point. A process can include tasks (also referred to as collaborative tasks) and meeting nodes (also referred to as conversational tasks where conversations between active entities and/or actors can occur), a graph that captures the interdependencies of the tasks and meeting nodes. A task can take information elements as input, and produce information elements or a result of decision-making as output. A roadmap and a process can be related. For example, before or after each checkpoint or decision point, a sub-process (a graph of tasks and/or meeting nodes) may be defined or executed. The process and roadmap do not have to be defined prior to execution. The process and roadmap definitions and their execution can occur simultaneously and be updated as the execution proceeds. A checkpoint, decision point, or meeting node is a subtype of a task; in other words, checkpoints, decision points and meeting nodes can be generalized as tasks in a case management social networking framework.

As noted above, an actor can interact with the active entities of a case. The interaction between an actor and the active entities of a case during enactment (execution) of the case (performance of the case) can result in the generation of information regarding the interactions. If a feedback mechanism is not provided relating to the interactions between an actor and the active entities of a case, then it would not be possible to learn from prior interactions when creating cases for other engagements.

In accordance with some implementations, a feedback mechanism is provided as part of the case management social networking framework to allow information pertaining to interactions between actors and case entities (e.g. a case, a process, a task, an artifact, an information element, a roadmap, etc.) to be collected and recorded. The collected feedback information can be the subject of analysis to produce analysis outputs that reflect the interactions between actors and case entities. The analysis outputs can allow for variations to be made in processes or roadmaps to achieve improvements and enhance efficiency in the performance of further engagements that may employ such processes or roadmaps.

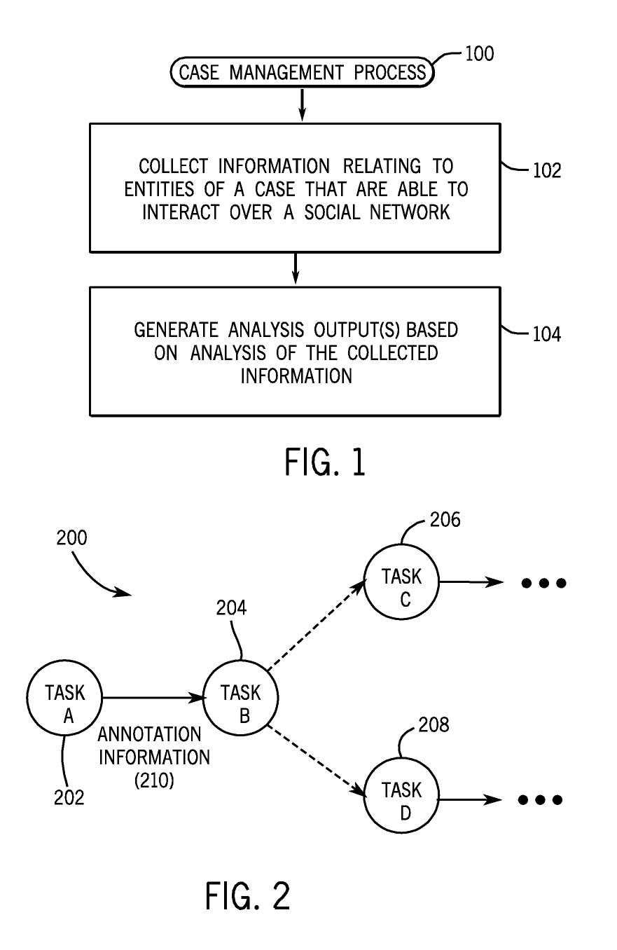

FIG. 1 is a flow diagram of a case management feedback process 100 according to some implementations. The case management feedback process 100 collects (at 102) feedback information relating to usage of entities (e.g. processes, tasks, roadmaps, artifacts, etc.) of a case, where the case entities interact over a social network of the case management social networking framework. Note that the case entities are not passive entities, but rather are active entities that are able to gather and generate data, as well as interact with each other and with actor(s) through the social network.

The collected feedback information relating usage of case entities is based on interactions between at least one actor and the case entities. The collected feedback information can reflect behaviors of the actor during enactment of the case. The collected feedback information can also indicate how processes, tasks, or roadmaps within a case were enacted in the case management social networking framework. Such information may be valuable when starting a new case for another engagement. In addition, the collected information can be used for determining whether changes should be made to a process profile, which describes details of the process, or to a roadmap profile, which describes details of a roadmap.

The feedback information collected during case enactment can involve decisions made by an actor with respect to performance of a case entity. For example, an actor may decide to skip a task, repeat a task, jump to a task, add a task, and so forth. The foregoing are examples of modifications that can be made with respect to tasks of a process in the case. Whenever a change or modification is made with respect to a process or any other case entity, information pertaining to such modification can be recorded in a modification event. Upon recording the modification event, the context of the case (including the configuration parameters of the case), comments made by the actor, and statistical information can be recorded. The modification event, case context, actor comments, and statistical information are further examples of feedback information that can be collected at 102.

In a specific example, configuration parameters for a case relating to sales of a product or service can include the size of a sales deal, a geographic region, and so forth. More generally, configuration parameters for a case can define various characteristics of an engagement (e.g. sales engagement, information technology project, product development project, etc.) that is represented by the case.

Examples of statistical information can indicate a number of cases that have included a particular change (e.g., skipping a task), and other statistical information.

The case management feedback process 100 further performs analysis on the collected feedback information to generate (at 104) one or multiple analysis outputs based on the analysis of the collected information. One or multiple analysis outputs can be generated as part of the analysis. In some implementations, an analysis output can include an annotated process model that is built from the collected information, where the annotated process model is a representation of a process that has inter-related tasks. The building of the annotated process model can be from structured information (that describes the structure of a process and links to other entities of the case), statistical information, and unstructured information (comments entered by a user). In further implementations, an analysis output can additionally or alternatively include an annotated roadmap model that is built from the collected information, where the annotated roadmap model is a representation of a roadmap that has checkpoints and decision points.

As shown in FIG. 2, in some examples, the annotated process model can include a dependency graph 200 that has nodes (e.g. 202, 204, 206, 208) representing tasks, and links representing transitions among the tasks. Each transition among tasks in the dependency graph can be labeled (annotated) with annotation information, such as annotation information 210 in the link between nodes 202 and 204. The annotation information 210 can include context information (e.g., values of the configuration parameters of the case), and keywords from the comments from cases where the corresponding tasks are used. Along with the context information, statistical information can also be added to the annotated process model.

An annotated roadmap model can similarly be represented by a graph, where nodes of the graph can represent checkpoints and decision points.

In further implementations, an additional or alternative analysis output can also include a recommended suggestion to be made to a profile of a process or to a profile of a roadmap.

As further examples, the analysis output(s) can also include a visualization of changes that have been made by an actor to a process or roadmap during case enactment. The changes to a case process or roadmap can be visualized to illustrate a suggested refinement to the process or roadmap. Visualizing the changes to be made can allow users or process owners or roadmap owners (users who have edit rights to edit process profiles or roadmap profiles, respectively) to more easily understand the context of each change, and to decide whether the process profile or roadmap profile is to be updated to take into account any statistically significant usage patterns.

Providing the analysis output(s) provides a historical representation (containing variations made in the case and behavior of actors that interact with the case) regarding usage of case entities. The analysis output(s) can enable the user, who may be composing a new case using an existing process profile or roadmap profile, to learn from previous experience by reviewing changes made to instances of the process or roadmap during past case enactments. A user can study task additions and removals (skips) in a previous enactment of a process or roadmap in a case, and may review comments submitted when a task was skipped or added to determine whether the same factors apply in the current case that is being composed. As a result, a user can make more well-informed decisions regarding the composition of a new case. As an example, the user can use the historical information to decide to keep a task. A user may also add a comment to the process profile or roadmap profile to state why the task is desirable in some cases, for the benefit of other users.

In this way, process profiles or roadmap profiles evolve over time, with accompanying statistics and comments regarding usage of the respective processes or roadmaps.

In some examples, during the collection process of 102 in FIG. 1, the collected feedback information can be recorded in an activity stream of a process profile or an activity stream of a roadmap profile (that describes a roadmap). The activity stream of a process profile or roadmap profile can refer to any representation of the process profile or roadmap profile to which feedback information can be posted. For example, such information can be in the form of the visualization in a display device, where collected feedback information can be posted to the visualization. Alternatively, the activity stream can be in the form of a file or other data structure.

In some implementations, a case manager (a user who is ultimately accountable for a case) can control whether changes made to a process or roadmap during case enactment should be propagated back to the corresponding process profile or roadmap profile, either during execution of the case, or after the case has completed. Alternatively, the case manager can also decide to not allow the changes to a process or roadmap to be propagated back to the process profile or roadmap profile, respectively.

When a change is propagated back to the process profile or roadmap profile, the context of the case (configuration parameters), usage statistical information, and actor comments can be recorded.

Various case entities according to some examples are further described below.

An artifact can refer to a document, an input form, a media item, or other item on which a task of a case can be performed. The artifact can include rich content, including video data, audio data, image data, text data, and so forth. An artifact can be considered to be an instance of an artifact template that provides a profile describing the artifact that is to be used as part of a best practices guideline for the management of a given case. An artifact template can be associated with an owner (who has authority to edit the artifact template). An artifact template can define multiple versions of the corresponding artifact. An artifact can be an input to or an output from a task or process.

A task can refer to an activity that is to be performed in a case. A task can have a profile, an owner, a set of attributes (including a state attribute that represents the state of the task), and a set of associated roles. Having a profile allows the task to be followed by social network actors (users or automated systems). At execution time, a task instance is instantiated from a task.

Examples of a state of a task can include the following: ready (indicating that the task is ready to be executed), assigned (indicating that the task has been assigned to an actor), pending (indicating that the task is waiting to be executed or is currently being executed), and completed (indicating that the task has completed). In other examples, a task can have other states. The owner of a task is an actor in the social network who has the authority to edit the task. A task can also have subtasks. A task can also be associated with one or multiple artifacts that can be input into or output from the task.

In some examples, a role that can be associated with a task can include any of the following: Accountable/Approver, Responsible, Follower. A role of a task is assigned to a respective actor. For example, an actor assigned the Accountable/Approver role is an actor who is accountable for completion of the task, and may be an actor who has to approve the task before the task is declared complete. An actor assigned the Responsible role may be an actor who performs the task. An actor assigned the Follower role is an actor who is interested in being informed of a status of the task as the task executes in the case.

A process can have a profile, and is composed of a set of tasks that are inter-related. The process can be represented by a task precedence graph, which shows relationships among the tasks of the process (e.g. a first task is performed prior to other tasks, where the first task produces an output that is used by the other tasks). The process can also have a set of one or multiple artifacts that constitute the input to or output from the process. In some implementations, the processes can be best practice processes to be provided by the case management social networking framework. A best practice process can refer to a process that is considered by an enterprise or user to conform to a target guideline with respect to performing work associated with a case.

A roadmap can also have a profile that defines the checkpoints (which can be considered milestones or synchronization points) and decision points (points at which decisions can be made) of the roadmap. The profile can indicate the set of information elements that are to be used at a checkpoint or decision point.

In some implementations, a case includes a process as a collection of inter-related tasks that are performed to achieve a certain goal, such as to achieve a sales goal, to handle a service engagement, and so forth. A case is associated with one or multiple process profiles that are enacted during the course of case management. Each process profile associated with the case identifies a process that is to be performed in the case. In other implementations, a case includes a roadmap (including checkpoints and decision points) and a process as a collection of inter-related tasks (collaborative or conversational) that are performed to achieve a certain goal. In the latter implementations, a case is associated with one or multiple roadmap profiles that describe key checkpoints and decision points, and process profiles that are enacted during the course of case management.

A case can also be associated with one or multiple actors that are involved in the case. Each actor can be assigned one of a number of roles in the case. One role is a case manager, who is ultimately accountable for the case. Other example roles can also be defined for actors involved in the case.

More generally, an actor can refer to a user or automated system in the social network that can take on a role in the case or with respect to a task (as discussed above). An active entity (e.g. case, roadmap, process, task, or artifact) can interact with the actor in the case management social networking framework.

The profile of a roadmap, process, task, or artifact can specify that the roadmap, process, task, or artifact subscribes to a particular case that uses the roadmap, process, task, or artifact. The subscribing process, task, or artifact can be informed about a change made to the process, task, or artifact during case enactment (performance of the case). The information regarding the change provides the subscribing entity (and actors) insight regarding how the respective entity (process, task, or artifact) is being used during case enactment. Such information can be used to modify subsequent behavior of the process, task, or artifact.

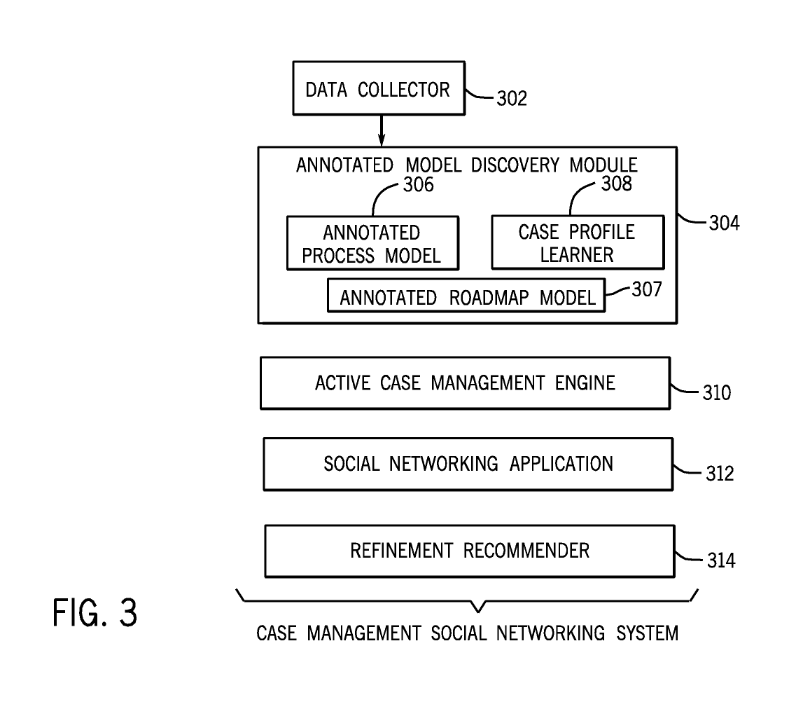

FIG. 3 illustrates an example system for providing a case management social networking framework according to some implementations. The system depicted in FIG. 3 can perform various functionalities such as those depicted in FIG. 1 and other functionalities.

The system of FIG. 3 includes a data collector 302, which is able to collect feedback information regarding usage of case entities and interactions between actors and case entities. In addition, the system includes an annotated model discovery module 304, which is able to generate an annotated process model 306 (e.g. an annotated process model similar to the example shown in FIG. 2) based on the collected feedback information. Similarly, the annotated model discovery module 304 can also learn an annotated roadmap model 307. In addition, the system includes a case profile learner 308, which is able to identify multiple types of cases, as discussed further below.

The annotated model discovery module 304 is able to learn the annotated process model 306 using various techniques. For example, the annotated model discovery module 304 can use techniques that include a hybrid of grammar inference and probabilistic approaches. In some examples, a Markov model can be used to identify sequences of tasks based on statistics about the tasks that frequently follow each other in past cases. The produced annotated process model 306 includes nodes that represent respective tasks, and links between the nodes to indicate dependencies among the nodes. An example of such an annotated process model 306 is depicted in FIG. 2. Similar techniques can be applied to learn the annotated roadmap model 307.

In addition, as noted above, the annotated model discovery module 304 can add annotations to the annotated process model 306, such as annotation information 210 depicted in FIG. 2, which can include case context information, usage statistical information, and actor comments. Similarly, the annotated model discovery module 304 can add annotations to the annotated roadmap model 307.

The system additionally includes a refinement recommender 210, which is able to recommend changes to be made to a process profile based on analysis of the feedback information.

An active case management engine 310 manages the enactment of cases. In some examples, the case management engine 310 provides a publish-subscribe arrangement. With the publish-subscribe arrangement, a subscribing active entity can subscribe to information pertaining to a publishing active entity (in other words, the subscribing active entity has subscribed to receive notification from the publishing active entity). Upon detecting status changes to the publishing active entity, the active case management engine 310 is able to propagate the status changes to the subscribing active entity. The active case management engine 310 can also offer flexibility features for case management in the social networking framework, to allow actors to skip tasks, add tasks, and so forth, for example.

The system of FIG. 3 also includes a social networking application 312 that provides the social networking framework to allow for participants (active entities associated with a case, and actors) to interact with each other through a social network. As an example, the social networking application 312 can be the WaterCooler application from the Hewlett Packard Co. In other examples, other types of social networking applications can be employed.

The system depicted in FIG. 3 further includes a refinement recommender 314, which can compare the discovered annotated process model (306) with a prior process model that may have been a starting point for one or multiple cases. Based on the comparison, the refinement recommender 314 can identify the differences, and based on these differences, the refinement recommender 314 can recommend changes to the process profiles to adapt to the discovered model 306. As noted above, the changes to a process profile can be presented to a user in a visualization. The visualized changes to a case process can depict a suggested refinement to the process. Visualizing the changes to be made can allow users to more easily understand the context of each change, and to decide whether the process profile is to be updated to take into account any statistically significant usage patterns.

The refinement recommender 314 can similarly compare a discovered annotated roadmap model (307) with a prior roadmap model for identifying differences and recommending changes to roadmap profiles.

The annotated model discovery module 304 and the refinement recommender 314 depicted in FIG. 3 are examples of modules that can perform the analysis to generate analysis output(s) in task 104 of FIG. 1.

As discussed above, the case profile learner 308 in the annotated model discovery module 304 is able to identify multiple classes of cases. In some implementations, the case profile learner 308 can perform clustering on the case profiles, where clusters of case profiles are identified based on similarity of respective case configuration parameters. Categorical, numerical, and other attributes representing the configuration parameters in the cases are also considered in the computation of similarity. A categorical attribute can indicate one of several categories, while a numerical attribute can have a range of numerical values.

Each identified cluster (based on the performed clustering) represents a respective case class. A case class can represent a corresponding combination of values of case configuration parameters that frequently occur together, based on some specified frequency threshold.

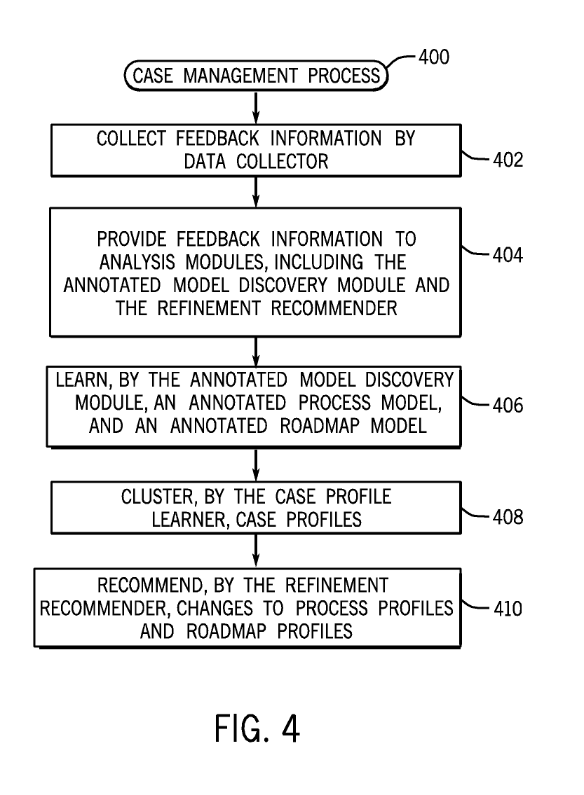

FIG. 4 is a flow diagram of a case management process 400 according to further implementations. During enactment of a case as managed by the active case management engine 312 of FIG. 3, the data collector 302 collects (at 402) feedback information relating to interactions between actor(s) and case entities, as well as feedback information relating to usage of the case entities. Interactions between an actor and a case entity (and between case entities) can occur through a social network provided by the social networking application 312

The collected feedback information is provided (at 404) to analysis modules of the case management social networking system, where the analysis modules can include the annotated model discovery module 304 and refinement recommender 314 of FIG. 3. The annotated model discovery module 304 learns (at 406) the annotated process model 306 and an annotated roadmap model 307 based on the collected feedback information. The case profile learner 308 can cluster (at 408) multiple case profiles to identify different classes of cases.

The refinement recommender 314 can recommend (at 410) changes to the process profiles and roadmap profiles to adapt to the discovered process model 306 and the discovered roadmap model 307, respectively. The recommended changes to a process profile or roadmap profile can be presented in a visualization.

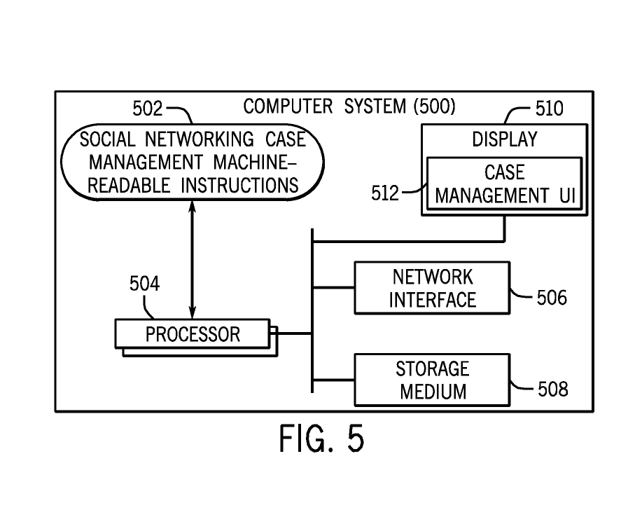

FIG. 5 depicts a computer system 500 that can incorporate some implementations. The computer system 500 can be implemented with one computer or a distributed arrangement of computers. The computer system 500 includes social networking case management machine-readable instructions 502, which can implement the various modules depicted in FIG. 3, for example.

The social networking case management machine-readable instructions 502 are executable on one or multiple processors 504, which can be connected to a network interface 506 (to allow the computer system 500 to communicate over a network. The processor(s) 504 can also be connected to a computer-readable or machine-readable storage medium (or storage media) 508. A processor can include a microprocessor, microcontroller, processor module or subsystem, programmable integrated circuit, programmable gate array, or another control or computing device.

The computer system also includes a display device 510, which can display a case management user interface 512 associated with the case management social networking framework. The case management user interface 512 allows a user to interact with the active entities of the case management social networking framework, such as through the social networking application 312 of FIG. 3. The case management user interface 512 can also be used by the refinement recommender 314 to visualize recommended changes to a process profile.

Storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
collecting, by a system having a processor, information relating to usage of entities of a case, wherein the entities include tasks and an artifact, the entities to interact over a social network; and
generating, by the system, an analysis output based on the collected information.

2. The method of claim 1, wherein the entities further include a process that includes the tasks, and wherein generating the analysis output comprises building a model representing the tasks of the process, where the model is annotated with the collected information.

3. The method of claim 2, wherein the model comprises a graph having nodes representing the tasks and links between the nodes representing an inter-relationship of the tasks.

4. The method of claim 2, wherein annotating the model comprises labeling portions of the model with case context information including configuration parameters.

5. The method of claim 2, wherein annotating the model comprises labeling portions of the model with comments added by at least one actor that interacts with the entities of the case during enactment of the case.

6. The method of claim 1, wherein the entities further include a roadmap that includes checkpoints and decision points, and wherein generating the analysis output comprises building a model representing the roadmap, where the model representing the roadmap is annotated with the collected information.

7. The method of claim 1, wherein generating the analysis output comprises generating a recommended suggestion for modifying a profile of a process in the case, wherein the process is one of the entities, and the process includes an inter-related arrangement of the tasks.

8. The method of claim 7, further comprising:
building a model of the process, the model representing the inter-related tasks and the model being annotated with the collected information; and
comparing the built model with a prior model of the process,
wherein the recommended suggestion for modifying the profile of the process is based on the comparing.

9. The method of claim 1, wherein generating the analysis output comprises generating a recommended suggestion for modifying a profile of a roadmap in the case, wherein the roadmap is one of the entities.

10. The method of claim 1, wherein the case has a first case profile, wherein additional case profiles are provided for additional respective cases, the method further comprising:
clustering the case profiles to identify plural classes of cases.

11. A system comprising:
at least one processor to:
collect feedback information relating to an interaction between an actor and at least one entity of a case, wherein the at least one entity includes a task of the case, and wherein the interaction between the actor and the at least one entity occurs over a social network;
provide the feedback information to an analysis module; and
perform, by the analysis module, an analysis on the feedback information to produce an analysis output based on the feedback information, the analysis output reflecting the interaction.

12. The system of claim 11, wherein the case includes entities including a process, tasks of the process, a roadmap, and an artifact, wherein the process, tasks, roadmap, and artifact are active entities to interact over the social network.

13. The system of claim 12, wherein the analysis output includes a model of the process or a model of the roadmap.

14. The system of claim 12, wherein the analysis output includes a recommended change to be made to a profile of the process or to a profile of the roadmap.

15. An article comprising at least one machine-readable storage medium storing instructions that upon execution cause a system to:
collect feedback information relating to usage of entities of a case, wherein the entities include tasks and an artifact, the entities to interact over a social network, and the feedback information further based on interaction of an actor with the entities; and
generate an analysis output based on the feedback information, the analysis output selected from among:
a model of a process in the case built based on the feedback information, and
a suggested change to be made to a profile of the process.
